(19) United States
(12) Patent Application Publication
(10) Pub. No.: US 2011/0012834 A1
(43) Pub. Date: Jan. 20, 2011

(54) HUMAN BODY ENGINEERIN MOUSE

(76) Inventor: Yong Guo, Guangzhou (CN)

Correspondence Address: CHARLES E. BAXLEY, ESQUIRE, 90 JOHN STREET, SUITE 403, NEW YORK, NY, 10038, US

(21) Appl. No.: 12/735,487

(22) PCT Filed: Jan. 22, 2008
(86) PCT No.: PCT/CN2008/000154

§ 371 Date: Sep. 7, 2010

(51) Int. Cl. G06F 3/033

(52) U.S. Cl. 345/163

(57) ABSTRACT

A human body engineering mouse is provided. The surface of the housing of the mouse contacting with a worktable is the bottom surface, the surface contacting with the hand is the top surface, the top surface includes a forefinger interface contracting with the forefinger, a palm interface contacting with the centre of the palm, a thumb interface configured in the inside of the housing and contacting with the thumb, and a gap for placing the finger is configured in the outside of the front side of the housing, and the gap commonly is used for placing the front side of the middle finger.

### FIELD OF THE INVENTION

The present invention relates to a data input device of the computer, and in particular to an ergonomic mouse.

### BACKGROUND OF THE INVENTION

Referring to the FIG. 1, when the hand is at rest position, the curved fingers and wrist joint, and the extended thumb are both in balance and stable state. In particular, when the wrist is horizontal with the palm facing downwards, the fingertips of four fingers excluding that of the thumb are arranged in step manner with the forefinger in front and followed by the middle finger, the third finger and the little finger at last. The forefinger is curved downwards slightly, and the middle finger, the third finger and the little finger are curved to a greater extent with the fingertips lower than that of the forefinger. The distance between the forefinger and the middle finger is the largest distance between two adjacent fingertips. The thumb is extended slightly outwards, and the other fingers close to each other.

A mouse is a data input device of the computer. The known mouse normally has the following structure: the contact surface between the housing and the worktable is the bottom surface, and the surface contacting with the user's hand is the top surface; the top surface is provided with an inner side button, an outer side button, wherein the side of the top surface close to the thumb is referred to as the inner side, and the side close to the little finger is referred to as the outer side; a mouse wheel is mounted between the two buttons.

The known mouse normally is symmetrical in shape and mainly moved by the cooperation of the thumb, the third finger and the palm. The forefinger and the middle finger are used for clicking the mouse. The middle finger, the third finger and the little finger are generally in extended state, which has the following problems after using the mouse for a relatively long time:

1. the hand is stiff and will get a repetitive strain injury;

2. the middle finger, the third finger and the little finger are in extended state and can not be curved naturally, which is uncomfortable;

3. the mouse direction is mainly controlled by the thumb and the third finger, which makes the movement of the mouse unstable.

### SUMMARY OF THE INVENTION

It is thus an object of the present invention to provide a mouse which is based on the ergonomics, and when in use, the middle finger, the third finger and the little finger are curved naturally, and the middle finger assists in controlling the movement of the mouse, and it is comfortable for use.

To achieve he above object, the present invention provides an ergonomic mouse, comprising:

a housing having a bottom surface for contacting with a worktable and a top surface for contacting with a user's hand;

wherein the top surface comprises a forefinger contact surface for contacting with a forefinger, a palm contact surface for contacting a palm, an thumb contact surface configured in the inner side of the housing and for contacting with the thumb, and a gap for placing a finger that is configured on the outer side of the front end of the housing.

When in use, the middle finger is normally placed in the gap on the outer side of the front end of the housing and in a naturally curved state. The middle finger is attached closely to the gap to assist in holding the mouse, which makes the positioning of the mouse more stable.

As an improvement to the present invention, the mouse further comprises an outer side button on the sidewall of the gap. The sidewall of the gap comprises a longitudinal sidewall extending in the longitudinal direction of the mouse and facing the outer side of the mouse, and a transversal sidewall extending along the transversal direction of the mouse and facing the front of the mouse. The outer side button is arranged on the transversal sidewall. The transversal sidewall has a lower portion recessed towards the rear end of the mouse. When in use, the middle finger is placed in the recess, and the outer side button can be actuated as the middle finger moves backwards. This structure is natural and rapid for operation.

Preferably, the transversal sidewall has a width close to the width of the middle finger. Thus, it will not be obstructive to the curve of the third finger during in use. The housing has an outer side contact surface for contacting with the third finger, and the outer side contact surface is recessed inwards. When in use, the third finger is placed in the recess of the outer side contact surface to enable the third finger to be in naturally curved state.

The forefinger contact surface is provided with a mouse wheel and an inner side button which are operated by the forefinger. The inner side button is provided on the outer side of the mouse wheel, and recessed with respect to the forefinger contact surface. The recess is complementary with the curved surface of the front end of the forefinger tip, which enables the finger to be relaxed and fatigueless. The inner side button is relatively close to the outer side button, and thus during operation it is only necessary to separate the forefinger and the middle finger slightly. If desired, the inner side button may also be provided on the inner side of or in front of the mouse wheel.

Preferably, the thumb contact surface is at an angle of 60° to 90° with respect to the worktable. When in use, the whole palm is inclined outwards, which makes the wrist comfortable.

### BRIEF DESCRIPTION OF THE DRAWINGS

FIG. 1 is a schematic view showing a hand in rest state;

FIG. 2 is a structural view of a mouse according to a first embodiment of the present invention;

FIG. 3 is a left side view of the mouse shown in FIG. 2;

FIG. 4 is a right side view of the mouse shown in FIG. 2;

FIG. 5 is a left view of the mouse shown in FIG. 3;

FIG. 6 is a structural view of a mouse according to a second embodiment of the present invention.

### REFERENCE NUMERAL

1. forefinger contact surface; 2. palm contact surface; 3. thumb contact surface; 4. gap; 5. outer side button; 6. inner side button; 7. mouse wheel; 8. longitudinal sidewall; 9. transversal sidewall; 10. outer side contact surface.

### DETAILED DESCRIPTION OF THE PREFERRED EMBODIMENT

### Embodiment 1

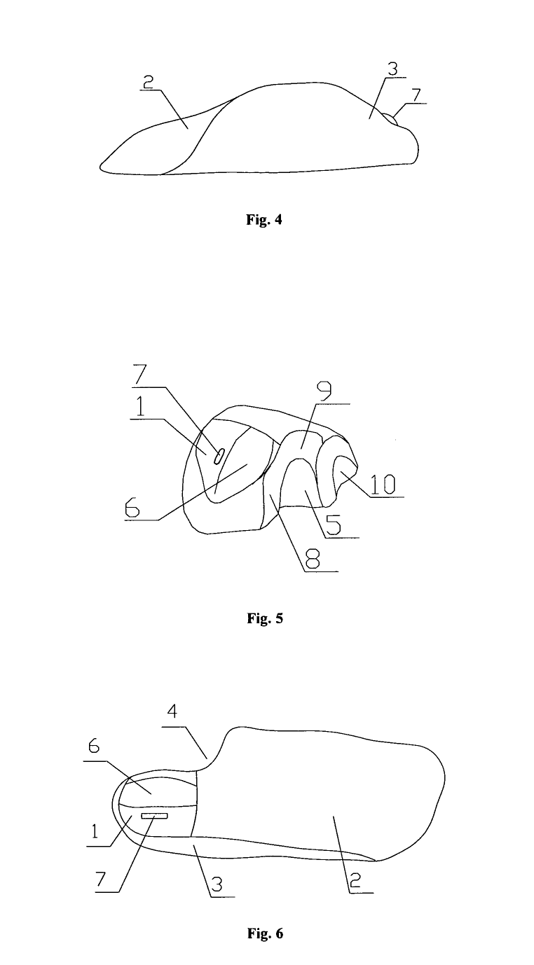

Referring to FIGS. 2 to 5, an ergonomic mouse which is adapted for left-handed use comprises: a housing having a bottom surface for contacting with a worktable and a top surface for contacting with a user's hand; wherein the top surface comprises a forefinger contact surface 1 for contacting with a forefinger, a palm contact surface 2 for contacting a palm, an thumb contact surface 3 configured in the inner side of the housing and for contacting with the thumb, and a gap 4 for placing a finger that is configured on the outer side of the front end of the housing.

The sidewall of the gap 4 comprises a longitudinal sidewall 8 extending in the longitudinal direction of the mouse and facing the outer side of the mouse, and a transversal sidewall 8 extending along the transversal direction of the mouse and facing the front of the mouse. The transversal sidewall 9 has a width close to the width of the middle finger. The transversal sidewall 9 has a lower portion recessed towards the rear end of the mouse. The thumb contact surface 3 is at an angle of 85° with respect to the worktable. The housing has an outer side contact surface 10 for contacting with the third finger, and the outer side contact surface 10 is recessed inwards. The mouse further comprises an outer side button 5, an inner side button 6 and a mouse wheel 7. The outer side button 5 is provided on the transversal sidewall 9 of the gap 4, and the inner side button 6 and the mouse wheel are both mounted on the forefinger contact surface 1. The inner side button 6 is provided on the outer side of the mouse wheel 7 and recessed with respect to the forefinger contact surface 1.

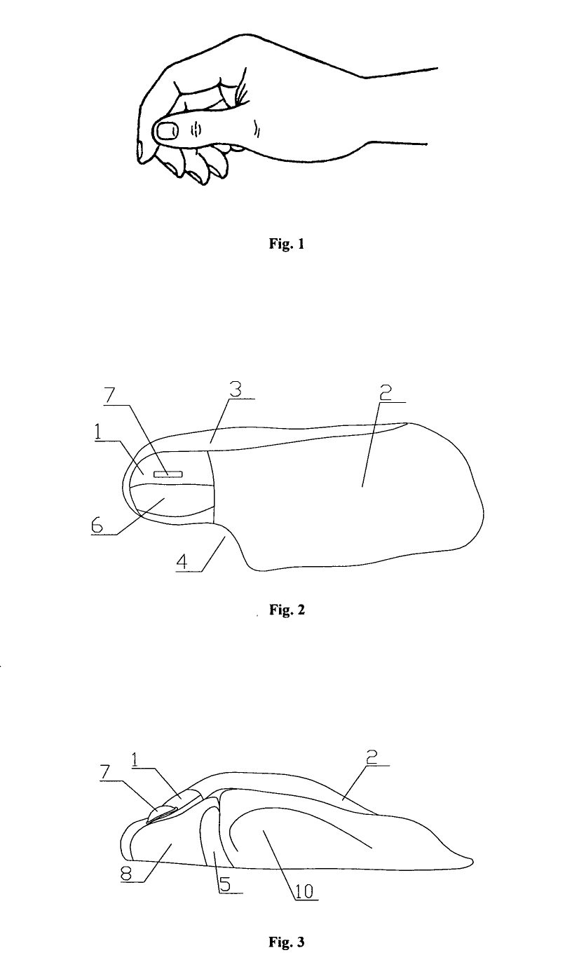

With reference to the FIG. 1, when in use, the thumb is attached to the thumb contact surface 3 that is inclined outwards, the forefinger is placed on the forefinger contact surface 1, and the middle finger is placed in the gap 4. The mouse is held by the thumb, the middle finger and the third finger from three directions such that the stability of the movement of mouse is maintained. The inner side button 6 and the mouse wheel 7 can be operated by the forefinger, and the outer side button 5 can be operated by the middle finger. When the middle finger is placed in the gap 4, the middle finger is in naturally curved state to avoid the fatigue of the middle finger. Similarly, the third finger is attached closely to the recessed outer side contact surface 10, and the thumb is attached closely to the thumb contact surface 3 such that the entire shape of the hand is in accordance with the rest state of the hand. Thus, it is comfortable and fatigueless for use.

### Embodiment 2

As shown in FIG. 6, the structure is symmetrical to that in the embodiment, and the mouse is for right-handed use. The principle is identical to that of the embodiment 1.

What is claimed is:

1. An ergonomic mouse, comprising:
a housing having a bottom surface for contacting with a worktable and a top surface for contacting with a hand;
wherein the top surface comprises a forefinger contact surface for contacting with a forefinger, a palm contact surface for contacting a palm, an thumb contact surface configured in the inner side of the housing and for contacting with the thumb, and a gap for placing a finger and configured on the outer side of the front end of the housing.

2. The ergonomic mouse of claim 1, wherein the mouse further comprises an outer side button arranged on the sidewall of the gap.

3. The ergonomic mouse of the claim 2, wherein the sidewall of the gap comprises a longitudinal sidewall extending in the longitudinal direction of the mouse and facing the outer side of the mouse, and a transversal sidewall extending along the transversal direction of the mouse and facing the front of the mouse.

4. The ergonomic mouse of the claim 3, wherein the outer side button is arranged on the transversal sidewall.

5. The ergonomic mouse of the claim 3, wherein the transversal sidewall has a lower portion recessed towards the rear end of the mouse.

6. The ergonomic mouse of the claim 3, wherein the transversal sidewall has a width close to the width of the middle finger.

7. The ergonomic mouse of claim 1 wherein the housing has an outer side contact surface for contacting with the third finger, the outer side contact surface is recessed inwards.

8. The ergonomic mouse of claim 1 wherein the forefinger contact surface is provided with a mouse wheel and an inner side button.

9. The ergonomic mouse of claim 8, wherein the inner side button is provided on the outer side of the mouse wheel.

10. The ergonomic mouse claim 1 wherein the thumb contact surface is at an angle of 60° to 90° with respect to the worktable.
